(19) United States
(12) Patent Application Publication
(10) Pub. No.: US 2002/0152179 A1
(43) Pub. Date: Oct. 17, 2002

(54) Remote payment method and system

(76) Inventor: Achiezer Racov, Sunningdale (GB)

Correspondence Address: SKADDEN, ARPS, SLATE, MEAGHER & FLOM LLP, ATTN: JAN STEELE, 525 UNIVERSITY AVENUE, SUITE 1100, PALO ALTO, CA, 94301, US

(21) Appl. No.: 10/033,154

(22) Filed: Oct. 25, 2001

Related U.S. Application Data
(60) Provisional application No. 60/244,062, filed on Oct. 27, 2000.

(51) Int. Cl. G06F 17/60

(52) U.S. Cl. 705/67

(57) ABSTRACT

A computer-based method and system for effecting a remote payment transaction involving the use of a mobile communications device. Using the described system and the communications device, a customer may electronically purchase goods, services, remit payments, track loyalty bonuses and effect enhanced personal financial account management with less effort, increased convenience and user-authorized security features for account access and manipulation. Using a mobile communications device, the customer instructs the remote payment system to provide funds to a merchant, where the funds are transferred from a customer account to a merchant account. If desired, the system automatically manages the value of these accounts by interacting with external financial accounts, such as bank accounts. The system also monitors transaction frequency and average account value to calculate a bonus to reward the customer's loyalty.

### CROSS-REFERENCE TO RELATED APPLICATIONS

This application claims the benefit of U.S. Provisional Application No. 60/244,062 entitled “Remote Payment Method and System,” filed Oct. 27, 2000, which is hereby incorporated by reference.

### FIELD OF THE INVENTION

The present invention relates to the general field of payment processing, and more particularly, to a method and system for the remote processing of payments between individuals, businesses, or a combination thereof, using mobile communications technology.

### BACKGROUND OF THE INVENTION

Historically, consumers have conducted financial transactions using face-to-face or other kinds of non-electronic channels. Such non-electronic channels of exchange, including the use of paper currency and coins, are conducted anonymously except when a payer, such as a customer, physically transfers these funds to payee, such as a merchant. Furthermore, if the paper currency or coins become lost, these funds cannot usually be replaced. Alternatively, the use of bank-issued checks may protect a payer against loss, and such checks can be tendered as payment to a remote party. However, because checks are a paper-based system, they must be physically managed by the recipient's bank, usually at a cost to the customer account. Also, a check that draws on insufficient funds often requires a merchant to undergo a costly and time-consuming process of securing the payment from the customer through some alternate channel.

The use of credit cards for payment can protect a user against loss and fraud; however, these transactions are not anonymous and are effectively used for payment only when a merchant is registered with the particular credit organization associated with such credit card. Also, a standard credit card has a fixed security method based on matching the payer's signature to that signature physically represented on the credit card, or alternatively, matching a payer's likeness to a photo located on the surface of such card. Thus, if the merchant and the credit card company are to be reasonably secure from the perpetration of fraud, then both the customer and the card must be present when the transaction is completed.

Debit cards represent yet another opportunity for a consumer to engage in secure cashless transactions. Like credit cards, these cards make use of a magnetic strip on the back of the card which is encoded with information about the cardholder and the account or accounts accessed by the card. Terminals, which may be automatic teller machines (ATMs) or merchant terminals at a place of business or point of sale, are used to read the coded information on the card and access the cardholder's account to complete a financial transaction.

In a debit card scenario, a debit card accesses finds that are directly in a customer bank account. Therefore, if sufficient funds are present in a customer bank account, the money is available for transfer. However, if insufficient funds are present in the account, the purchase process cannot move forward. The debit card provides for a direct transfer of funds, since funds are electronically transferred out of the customer account when the customer makes the transaction. However, there is usually some delay for such money to be actually deposited in a merchant bank account; the merchant must wait until the financial institution performs a daily reconciliation of both the customer and merchant bank accounts before the money becomes available for spending.

Stored value cards are also becoming increasingly popular. A stored value card is a card that is purchased or provided with a specific monetary amount, which is stored on the card. When the cardholder desires to use the stored value card to purchase goods or services, the card is presented at the point of sale and the cost of the goods or services purchased is deducted from the value of the card.

Recent developments in chip card technology have enhanced the security aspects of various payment models by linking a Personal Identification Number (or “PIN”) to a debit or credit card instead of a signature. However, the use of a PIN still requires the customer and the card to be physically present as the transaction is completed.

To overcome these problems, credit card companies have introduced a process known as “card-holder not present” (or “CNP”) transactions. CNP transactions do not require a signature, however, the customer can potentially repudiate a completed transaction by disputing the transaction with the credit institution. Such repudiation can result in a financial loss to the involved merchant, rather than the credit card company.

Another type of payment model for immediate receipt of finds in a cashless transaction includes electronic payment methods using a smart card. Rather than employing information encoded on a magnetic strip, smart cards incorporate a microprocessor which is embedded in the card and can interact with an ATM or a merchant smart card terminal to provide information about the cardholder or the cardholder's account or transaction authorization. Furthermore, the card can be included in a portable device such as a laptop computer, a cellular telephone, or a personal digital assistant.

One such method uses a smart card as an electronic wallet. A smart card typically includes a microchip that has storage capability and can store currency as an electronic credit. Such currency can be derived from a customer bank account and then represented in electronic form on the smart card. A paying party can electronically transfer this credit to the payee party on the other side of the transaction using a smart card reader. However, to conduct a transaction with an electronic wallet, the payer typically gives the wallet to the payee, who then contacts the wallet with the smart card reader to complete the transaction. From the point of view of the payer, this method of conducting a cash transaction requires placing a degree of confidence in the payee to properly enter the details of the purchase into the smart card reader.

Developments in the field of encryption technology suitable for electronic payments, including the Public Key Infrastructure and Secure Electronic Transactions process, have been proposed as a new standard for Internet transactions. However, both of these techniques require an extensive administrative and hardware infrastructure to manage the private keys and further, additional software must be installed on all customer equipment.

One problem commonly associated with the use of credit card forms of payment is the substantial cost of the transaction to the merchant. For payments having a low value, such as micro-payments, the cost incurred by the transaction has the potential to be more than the actual payment. Thus, credit cards are not suitable for transactions involving micro-payments.

There have been several attempts to produce devices and systems that can handle micro-payments and low value transactions without incurring the overhead of standard credit cards or other similar types of financial products. These devices and systems can be generally divided into two classes, described below.

One class requires the use of additional devices or cards, such as the Mondex system, which is modeled after the paper bill and coin system. The Mondex system features a device, such as a smart card, having an embedded microprocessor that electronically stores money. After a customer actively loads money onto the card, the customer can use the card for purchases, by interacting the card with a smart card reader located at the point of sale. Therefore, this transfer ability requires all merchants to install these smart card readers, which are often expensive to purchase, install, and maintain. Also, customers must actively and continually load money onto their smart card, as the value of the card is depleted. This money gains no interest while it is on the card, and if the card is lost, the currency cannot be replaced.

The second classification of a device that can handle micro-payments includes Internet-based systems, including the DigiCash system. The DigiCash system is designed to be used in combination with the Internet, and interacts with electronic currency that is stored directly on the customer's PC hardware. Thus, the system is not a mobile system of payment, and further, is not adapted for use without an active Internet connection.

Therefore, there is a need for an improved method for effecting remote payments, which avoids the shortcomings and drawbacks of the existing methods and systems.

There is also a need for a remote payment method and system that offers enhanced convenience when assisting a customer in executing a transaction, where the customer can effect a remote payment in a manner that benefits the customer as well as the other parties involved or associated with the remote payment transaction.

There is also a need for a payment method and system that can provide current, updated account information, including recent transaction information, to a party for that party's account stored on the server within the remote payment system.

Furthermore, there is a need for a payment system that is environmentally sensitive and will, in its fullest implementation, substantially reduce the demand for paper currency in addition to any expenditure associated with the manufacture and transport of such currency.

Accordingly, it would be advantageous to have a method and system for the remote processing of payments that allows transacting parties to exchange money using one or more electronic accounts in an automated and optionally anonymous manner. In addition, it would be advantageous to have a system for remote payment transactions where the transacting parties can manage one or more financial accounts to control the balances of these accounts to ensure sufficient funds are available for the remote payment transaction.

### SUMMARY OF THE INVENTION

The present invention is a method and system for providing secure, cost-effective transactions of any amount using a remote communications device, such as a mobile phone, and an electronic server, such as a payment server. The method and system offer numerous advantages to parties interested in conducting remote payment transactions, including consumers, providers of financial services, and merchants or other parties acting as payers or payees.

According to the present invention, a user employs a mobile communications device that is adapted for secure, real-time, interactive communication, to instruct an electronic server, such as a payment server, to transfer funds between one or more accounts stored on the server. The user's server-based accounts can be refilled at the user's command, using financial accounts external to the server, such as a bank account, having a cash value.

The mobile communications device used with the present system and method provides a simple, secure, and inexpensive mechanism that can interact in a variety of ways with an electronic server, such as accessing, controlling, instructing, requesting, and querying the payment server. A user, such as a customer, can enter command messages from the mobile communications device that direct the server to supply information on a real-time basis to the user. Such information can include multimedia information such as text, data, calculations, reports, voice, sound and graphic information.

The remote communications device includes a microprocessor or other transmitting means to transmit transaction data to the server. The remote communications device also preferably includes a display unit for viewing data that is transmitted from the payment server or, alternatively, data that is received from a connection with the Internet. Such data can include a payment frame where a customer uses data fields within the payment frame to command the payment server to implement a payment instruction. Furthermore, the communications device can interact with a security subsystem that is electronically coupled to the payment server. Such a security subsystem requires the customer to provide authenticating information, which allows a user to confidentially and interactively access the user's account information and to initiate a remote payment transaction.

A user can send an instruction to the payment server, including without limitation, commanding the server to access an account, make a payment, transfer funds, provide an account activity report, enter an order for a product, or view loyalty award information that has been awarded to the customer because of frequent account usage or high average account value, or a combination thereof.

The customer can establish the authorization rules for a remote payment having a specific value. Because the customer can authorize the security parameters and the payment limit for each individual transaction, the customer cannot subsequently repudiate this transaction after the payment server has executed these procedures.

Furthermore, the method and system provides each account owner with direct control over who can be an authorized user, what account can be used to originate a remote payment, and finally, what kind of authentication is required to complete the transaction. Such authentication methods may include, without limitation, biometric techniques including voice recognition or signature recognition, which can be accepted by the payment server through, for example, a sound receiver or touch sensitive pad that is located in proximity to the communications device.

The remote payment method and system of the present invention links an account, such as a customer account, to a remote communications device, such as a mobile phone. The customer uses the mobile phone to interact with the payment server and manage the customer account by sending payment instructions to the account, transferring funds into or from the account into a second account, or checking the account balance. The mobile phone also acts as a physical token linked to the security system so a user of said phone can access the customer account.

A customer can transfer an electronic credit to the customer server account from a customer bank account held at a financial institution, such as a bank, or alternatively, the customer can receive a credit from some other cash account. A customer may spend this credit on a purchase, such transaction initiated from the mobile phone. Since the credit is held in a central location, the customer does not forfeit the credit if the mobile phone is lost.

The remote payment system and method operates using a communications device such as a standard phone, a mobile phone, or a personal digital assistant. Moreover, the present invention is adapted for remote payment over almost any type of remote connection or communications network, including the Internet, Wireless Application Protocol (or “WAP”) Phones, and an infrared signal originating from a mobile communications device to a fixed base station.

The remote payment system and method also provides the customer with a loyalty bonus for using the remote payment account. In an exemplary embodiment, the bonus can include, without limitation, additional airtime minutes from the mobile phone company activating the communications device. Such bonus is adapted to be used by the customer or alternatively, the bonus may be transferred to another user such as a family member. A typical bonus value is based upon the usage of the customer account. Such usage can be determined by, without limitation, the balance of funds in the account, the volume of transaction activity, or the value of such transactions.

The structure and complexity of the system of the present invention suggests that the system is preferably implemented with a real time, on-line, transaction processing and operating system. As described below, the system is adapted to provide an account holder with a real time update of the holder's accounts that are stored on the remote payment server. The payment server operatively engages both the customer and merchant server accounts in addition to coordinating, managing, planning, analyzing, and reporting on various activities of these server accounts among and between the system modules, including a financial institution and a telecommunications company.

### BRIEF DESCRIPTION OF THE DRAWINGS

These and other objects, features, and advantages of the invention will be more readily apparent from the following detailed description in which:

FIG. 1 illustrates an exemplary architecture of the ICOM Customer Purchasing Process of the present invention;

FIG. 2 illustrates an exemplary architecture of the ICOM Funds Transfer Process;

FIG. 3 illustrates an exemplary flowchart of the ICOM Registration Process;

FIG. 4 illustrates an exemplary flowchart of the ICOM Security Setting Process;

FIG. 5 depicts an exemplary flowchart of the ICOM Security Authorization Process used in combination with the ICOM Security Setting Process;

FIG. 6 shows a schematic overview of an exemplary ICOM Loyalty Process;

FIG. 7 illustrates an overview of the basic interactions according to the ICOM Remote Payment System using the Internet; and

FIG. 8 depicts an overview of the function and operation of the ICOM Remote Payment System.

### DETAILED DESCRIPTION OF THE INVENTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention.

The method and system according to the present invention provides secure remote payment processing using an integrated and interactive system for funds transfer between, and management of, one or more accounts. Such transfer is effectuated using a remote communications device, such as a mobile phone, in cooperation with a server, such as a payment server.

The ICOM Remote Payment System (herein “ICOM”) server works with a service provider to provide a customer with the flexibility to securely and efficiently manage a remote transfer of value for goods and services from one account to another. For example, withdrawals, deposits and transfers can be easily made by the ICOM payment server upon a customer instruction, after the customer has initiated a session with ICOM. Furthermore, the ICOM method and system of the present invention can be accessed by a customer via a remote communications device, such as a mobile phone. The customer can register such device with ICOM and use the device as a physical token in connection with the ICOM security framework.

In an exemplary embodiment of the invention, a plurality of money transfer schemes are available, including but not limited to, customer-initiated low value purchases and top-up cash account transfers. The latter form of transfer occurs when the customer adds value to the customer's ICOM server account using another account (e.g. a bank account) as a funds source.

ICOM also provides the customer with the flexibility to either increase or decrease the balance of the customer's ICOM server account. The customer can link the ICOM customer server account with a customer financial account, such as a bank account, and instruct ICOM to maintain the ICOM server account within a designated account value range. When the value of the ICOM customer server account falls below or rises above this balance range, ICOM can automatically instruct the bank to transfer value from or to the customer bank account to return the ICOM customer server account to the specified balance range. Alternatively, the customer can manually initiate this transfer process by using the remote communications device to contact ICOM and provide an appropriate transfer instruction.

According to the present invention, the customer can set up a personalized user authorization scheme that establishes a particular level of security for each ICOM customer account. This security scheme operates when a customer or other authorized user attempts to access the ICOM customer account held on the ICOM payment server. A customer can also establish a security level for a transaction with a specific merchant, a specific transaction amount or range of transaction amounts, or for a specific authorized account user or users. Also, since the account is stored at a remote location, if the customer loses the communications device, the cash value of the account and established security features remain intact, since the account and security functions are remotely stored on the payment server.

Other parties besides the customer also benefit from using the ICOM method and system. For example, ICOM benefits a merchant for several reasons. First, the risk associated with consumer fraud is minimized. Because the customer can establish the security authorization procedures for each remote payment transaction, the customer cannot repudiate a completed transaction. Second, ICOM is cost effective for micro-payment type and low value transactions because each payment transfer has a nominal transaction cost. Finally, because ICOM rewards the customer's loyalty, the merchant receives secondary benefits from the good will associated with the ICOM loyalty program.

The ICOM system and method also benefits other parties, such as the telecommunications company sponsoring the customer's mobile communications device and the financial institution where ICOM, the customer, and the merchant are new or established account holders.

For example, ICOM is advantageous for a telecommunications company (“Telco”) because Telco can charge the customer for each call to the ICOM server (e.g., either because the airtime is deducted from the contractual amount of airtime or because the customer incurs a long distance charge when accessing the ICOM server from outside the customer's local calling area). As customers increase their usage of the ICOM, the amount of the airtime loyalty bonus transmitted by ICOM to the Telco also increases. As a customer accumulates the loyalty bonus, the customer may be encouraged to maintain the Telco account, and not switch over to a competitor Telco. Therefore, Telco may further benefit by an increased usage level and market penetration, especially if the ICOM customer elects to transfer the loyalty bonus to a new or existing third party Telco user. Furthermore, any significant increase in customer use of ICOM may not only increase Telco's market share for a particular geographical area, but may also lessen Telco's financial burden associated with the costly distribution of monthly billing statements, since customers can pay for Telco services remotely using their ICOM server account.

ICOM is also advantageous for the associated financial institutions, such as a bank (“bank”), because the bank can benefit from increased market share associated with ICOM co-promotional activities. Furthermore, the bank can gain additional benefits by offering customers the security of linking a bank account to Internet payments, a broader customer base, and potential increases in profit associated with account fees for new customers who link an ICOM server account with a new customer bank account. Furthermore, the bank can also profit from interest gained as funds are transferred from a party's ICOM server account to a party's bank account or the ICOM cash bank account. The bank can optionally share these profits with other ICOM participants, such as the customer's Telco.

The ICOM payment server may be implemented on a network of one or more of the following: microcomputers, minicomputers, workstations, file servers, computer server, data base management system servers, mainframe computers, supercomputers, or massively parallel processing computers. The payment server preferably maintains a computer system that integrates different types of computer subsystems into a single unified system, further comprising an interface that can be accessed remotely by a customer using a communications device. Furthermore, those skilled in the art will appreciate, without limitation, the use of the term “subsystem” to describe an element for implementing a process, processes, or a combination thereof.

To more fully understand the ICOM payment method and system, detailed descriptions and drawings are provided in the following sections. The ICOM system and method are comprised of a plurality of components, including those exemplary components defined below.

The ICOM Mobile Payment Flow refers to a process that employs a Frame Based Payment Generation (“FBPG”) structure to enable a customer to make an electronic payment to a designated recipient using a mobile communications device. FBPG is a flexible process, supporting a wide variety of payment methods, including, but not limited to, a payment originated by a customer to a merchant or other similar kinds of person-to-person payments using the ICOM system. Furthermore, the FBPG process provides a framework where parties can conduct a secure transaction that cannot subsequently be repudiated by either party, i.e., by either the customer or the merchant.

The ICOM Customer Variable Level Security feature refers to a process that operates within the ICOM security authentication subsystem. This feature permits a customer to establish the level of security required to access and manage an ICOM customer account stored on the ICOM server.

The Air Time Loyalty Bonus operates according to an ICOM customer loyalty subsystem that provides a customer with a loyalty bonus under several conditions. For example, this ICOM loyalty subsystem can calculate the loyalty bonus for each customer according to the aggregate amount of ICOM activity associated with the remote payment for goods and services using an ICOM customer account. Alternatively, ICOM may calculate the loyalty bonus based on the amount of funds kept in one or more ICOM customer accounts. The loyalty bonus can also be based on a combination of these factors.

The ICOM Internet Payment using Mobile Phones (“IPMP”) refers to a system and method that extends the remote payment scheme to those transactions resulting from a customer purchase over a global electronic network, such as the Internet. The ICOM IPMP process protects the confidential information of the customer, including the customer identity and ICOM account number, by conducting the transaction using anonymous account parameters.

Those skilled in the art will appreciate, without limitation, the use of the term Internet to describe any open network using any combination of computer, telephone, microwave, satellite, and/or cable networks.

Those skilled in the art will also appreciate, without limitation, the use of the terms “ICOM server” and “ICOM payment server” when describing the embodiments of the present system and method.

As described above, FBPG provides a universal framework adapted to support a plurality of local and remote payment transactions. A customer can conduct such transactions using a remote communications device, such as a mobile phone, to manage the flow of payments between one or more persons, a person-to-machine, and a person-to-information provider over the Internet.

In one embodiment, a payee, a payer, and a transaction value define a basic payment transaction using the ICOM payment server. In some kinds of transactions, additional information such as a payment date, payee authorization code, or confirmation receipt is required. Furthermore, in other kinds of transactions, an intermediary or other type of agent may represent the payee or the payer.

The ICOM system provides the transacting parties with a FBPG scheme that contains data fields for transaction data that are necessary for the customer to complete a remote payment. Such frames include, for example, various rules that define the transacting parties and payment authentication procedures. In one embodiment, ICOM is implemented using standard JAVA objects. The information and process flow for the operation and functionality of the ICOM payment system are then driven by the JAVA object methods.

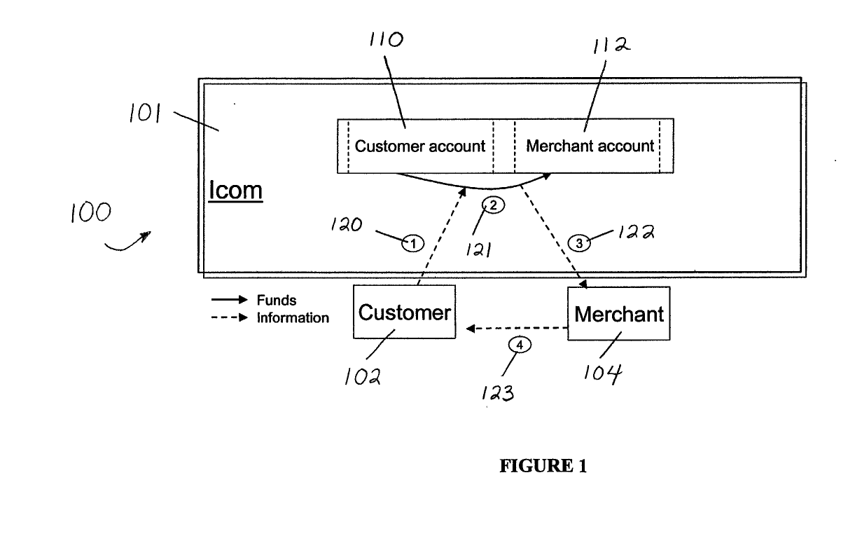

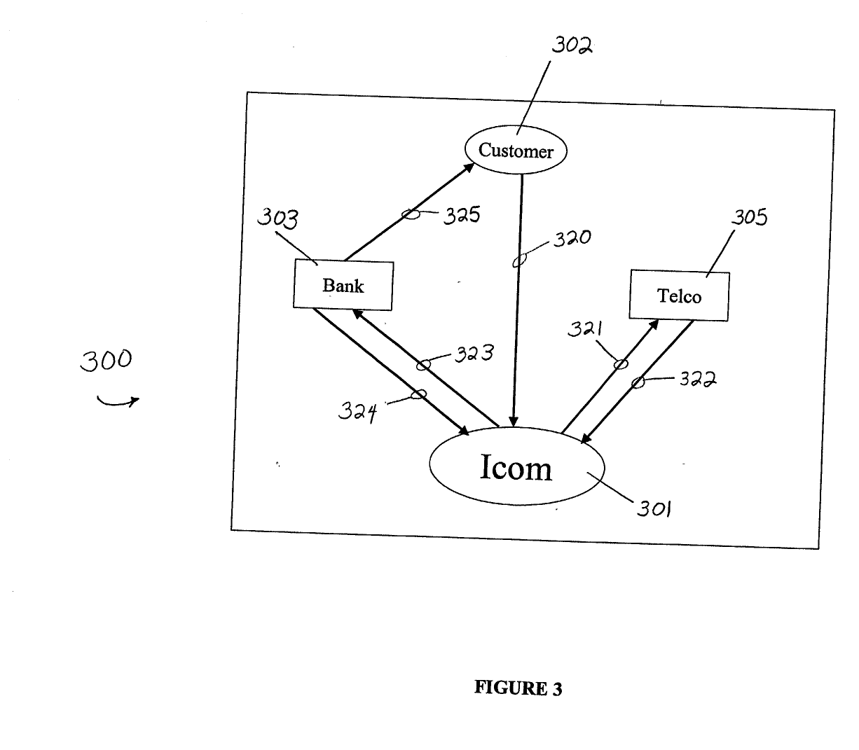

FIG. 1 illustrates an exemplary architecture of the ICOM Customer Purchase Process. Briefly, ICOM 101 establishes and maintains a secure session with each transacting party, such as an ICOM registered customer 102 and an ICOM registered merchant 104. These transacting parties have previously registered with the ICOM system, preferably according to the embodiment shown in FIG. 3. To begin the transaction, ICOM payment server 101 collects all the required data from the customer 102 and merchant 104 that are necessary to complete the remote payment transaction. Such data may originate from one or more sources, including without limitation, a customer mobile phone or a merchant dedicated line to the ICOM server 101.

The duration of each session between ICOM and the payer (e.g., customer) typically lasts only for the time it takes to make a remote payment, while the length of each session with the payee (e.g., merchant) may extend over a series of payments. By way of example, the merchant can be an agent, such as a ticket machine, where the machine accepts multiple payments from one or more customers using the ICOM payment server to process each payment transaction. At the end of each business day, the machine can then initiate one remote payment session with the ICOM server to process each transaction, or alternatively, the machine can initiate a payment session with ICOM after each individual transaction with the customer.

According to the present invention, customer 102 can interact 120 with ICOM 101 to engage a variety of functions, including but not limited to, registering for a new ICOM account, inquiring about account balance, establishing new or changing existing payment authorization schemes, and requesting recent transaction history.

A customer 102 can also authorize one or more authorized users of the customer's ICOM account 110 to make remote payments. The customer 102 can also establish the type of payment that may be transacted using the ICOM customer account 110. For example, a parent could authorize a child as a authorized user of the parent's ICOM account, and permit the child to spend up to a pre-set limit without any restrictions. Any transaction amount that surpasses this pre-set limit would require additional authorization from the parent. Another example of the ICOM account authorization feature is where a parent authorizes a child's request to transfer funds to a taxi driver, but denies another request when the same child requests a transfer of funds to a bartender.

Referring again to FIG. 1, an exemplary embodiment of the ICOM customer purchase process is shown where an ICOM customer 102 uses a mobile communications device to make low value payments to an ICOM enabled merchant 104 for goods or services provided by the merchant 104.

As explained more fully below, the customer 102 uses a mobile phone to convey a payment instruction 120 to ICOM 101 using the payment frame structure illustrated in Table 1. The customer 102 provides input to each data field contained within the frame using the keypad on the mobile phone, or alternatively, by responding to voice-activated requests for information. After ICOM 101 receives the customer payment instruction 120, ICOM 101 then notifies customer 102 that the ICOM 101 has successfully received the payment instruction. ICOM then transfers the funds 121 from ICOM customer account 110 to ICOM merchant account 112. Following the funds transfer step 121, ICOM then notifies 122 merchant 104 that ICOM completed the funds transfer. In one embodiment of the notification step 122, customer 102 can authorize ICOM 101 to disclose customer contact information to the merchant 104 if customer 102 requested the delivery of the goods or services. In another embodiment, the merchant 104 confirms 123 the funds transfer 121 with the customer 102, such confirmation step 123 occurs independently of the ICOM payment server 101.

As a further example, using the method and system of the present invention, a customer contacts an ICOM enabled train ticketing service using the customer's mobile phone to purchase a train ticket. In one embodiment, an ICOM Interactive Voice Response (“IVR”) subsystem prompts the customer through the booking process using biometric voice recognition. Such a booking process includes a customer's vocal instruction to initiate a funds transfer between a customer ICOM account 110 and an ICOM merchant account 112 via the ICOM payment server. Following this funds transfer, the IVR subsystem asks the customer to confirm payment for the customer requested ticket. The customer inputs a response corresponding to “yes” or “no” to complete the remote payment transaction.

As described above, the remote payment transaction is accomplished using a payment frame that comprises one or more data fields having an associated function that is responsible for implementing each data field. A payment frame according to the FBPG format, for an exemplary ICOM Mobile Payment Flow is illustrated in Table 1.

TABLE 1
Exemplary Payment Frame

| Data Field | Rule | Comment |
|---|---|---|
| Payer_ID | CLI + PIN | Authenticates customer using a |
| | | mobile communications device and |
| | | a PIN specific to that customer. |
| Payee_ID | DDI | References the merchant ICOM |
| | | account. |
| Currency | Payee_default | The default currency used to |
| | | conduct the remote payment |
| | | transaction. |
| Amount | Payee_generated | The merchant system generates |
| | | a payment amount. |
| Date | Today | |
| Payer reference | Null | |
| number | | |
| Payee reference | Null | |
| number | | |
| Payee | Customer | Confirm payment details with |
| authentication | | customer security authorization for |
| | | the transaction. |
| Payer | Null | |
| authentication | | |
| Payee notification | IVR | Confirmation of payment to the |
| | | payee merchant. |
| Payer notification | e-mail | The payer customer provides an |
| | | e-mail account for receiving ICOM |
| | | confirmation that remote payment |
| | | has been completed. |

For the purposes of illustration, the payer_ID data field requires a Calling Line Identification (“CLI”) data item, where the ICOM server 101 receiving the incoming customer call can detect the number assigned to the mobile communications device originating the call. Also, the Payee_ID field optionally uses a Direct Dial Interface (“DDI”), where the ICOM server is connected to one or more phone lines. The DDI permits ICOM to recognize a call to a number dedicated to a particular merchant as a call to that merchant's ICOM account.

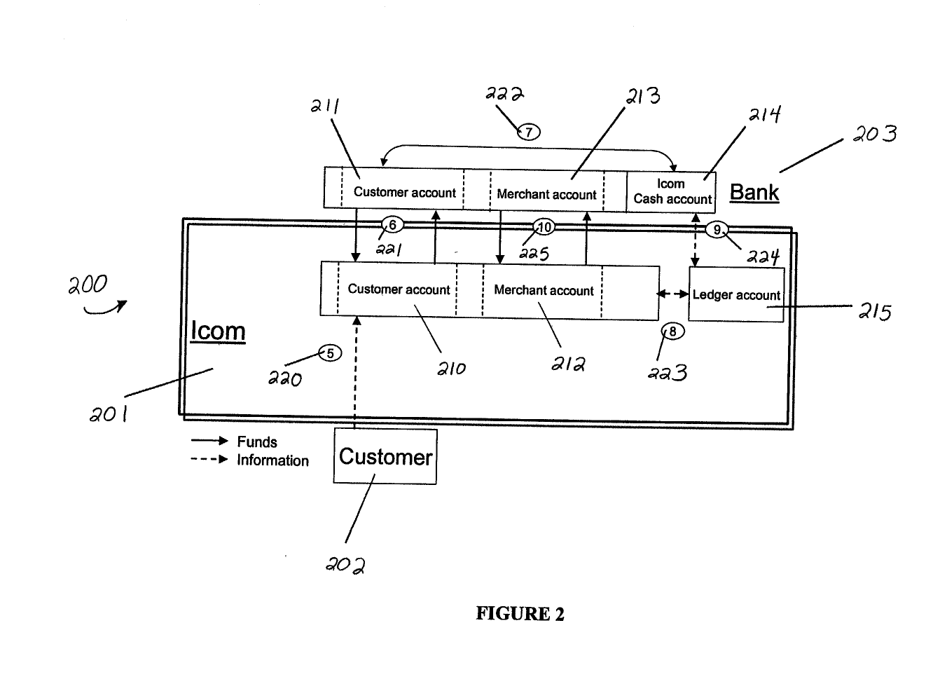

FIG. 2 shows an exemplary embodiment of the ICOM Funds Transfer Process 200 according to the present invention. Briefly, an ICOM customer 202 can use a mobile communications device to initiate a session with the ICOM payment server 201 to manage the customer's account, including without limitation, the tasks of making a remote transfer, allocating funds from one account to another, or querying the server to ascertain the balance or transaction activity for one or more ICOM customer accounts.

Through the ICOM Funds Transfer Process 200, a customer 202 can engage the ICOM payment server 201 using a mobile phone to control the allocation of finds between one or more ICOM customer accounts 210 and one or more customer bank accounts 211. For example, using a mobile phone, customer 202 can initiate a finds transfer request 220 to the ICOM server 201 to transfer 221 a specified amount of funds from the customer bank account 211 to the ICOM customer server account 210. ICOM 201 then transfers 221 the requested value to the ICOM customer server account 210, where this value is represented as an electronic credit.

The transfer of funds 221 can be manually initiated 220 by the customer 202, where customer 202 instructs ICOM to credit or debit the ICOM customer server account 210 using the finds held in the customer bank account 211. Alternatively, ICOM can automatically transfer the funds 221 from the ICOM customer server account 210 to the customer bank account 211 according to a customer instruction specifying that ICOM maintain the ICOM customer server account 210 at a balance between a minimum and maximum amount that has been predetermined by the customer 202.

For each transfer step 221, ICOM 201 also instructs the bank 203 to transfer funds 222 corresponding to the customer transfer instruction 220, from the customer bank account 211 to the ICOM cash bank account 214. The bank 203 then adjusts the ICOM cash bank account 214 to reflect the amount of funds transferred. For example, if the customer 202 instructs 220 the ICOM server 201 to transfer value 221 from the ICOM customer server account 210 to the customer bank account 211, bank 203 accordingly debits 222 the ICOM cash bank account 214 and credits the customer bank account 211 in this amount. Conversely, if the customer instructs 220 the ICOM server 201 to transfer value 221 from the customer bank account 211 to the ICOM customer server account 210, the bank 203 will accordingly credit 222 the ICOM cash bank account 214 and debit 222 the customer bank account 211 in the requested amount.

After the bank transfers 222 the funds to or from the ICOM cash bank account 214 in step 222, the ICOM payment server 201 updates and balances 223 the ICOM Ledger account 215 to reflect any changes to the amount of total funds present in all accounts held on the ICOM payment server 201.

In a further embodiment of the ICOM Funds Transfer Process 200, ICOM transfers funds 225 from an ICOM merchant account 212 to the merchant bank account 213. Such a transfer step 225 between these two accounts typically follows a merchant mandate to make the transfer, where such mandate may be automatically initiated at a particular point in time or alternatively, when the merchant ICOM account 212 reaches a particular value level. After the transfer 225, ICOM balances 224 the ICOM Ledger account 215 with the ICOM cash bank account 214 to reflect any changes to the amount of total funds present in all accounts held on the ICOM payment server 201.

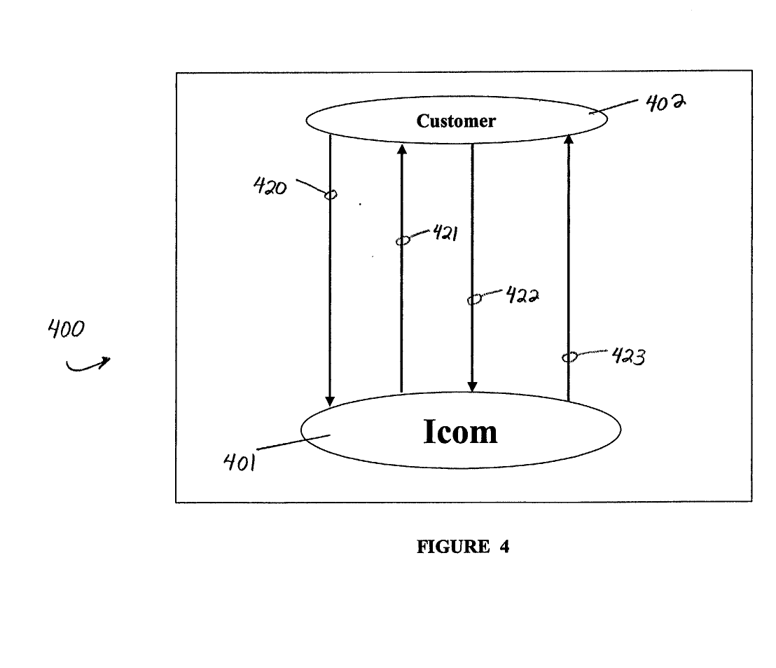

FIG. 3 illustrates an exemplary embodiment of the ICOM Registration Process 300, which features a customer variable security (“CVLS”) subsystem. The CVLS subsystem provides the customer 302 with a mechanism of establishing a level of security for a specific payment transaction or series of transactions. The CVLS subsystem is a part of the ICOM security registration process depicted in FIG. 4 and described below. The CVLS subsystem functions by combining confidential customer information from one or more independent sources, including a financial institution such as a Bank 303 and a telecommunications entity (“Telco”) 305, specifically a Telco 305 providing continued activation of the customer's mobile communications device. Such information, which is collectively known only to the customer, is securely stored on the ICOM payment server. The confidential customer information can include, without limitation, an encrypted PIN, bank account details such as the routing information and account number, a designated phone number for the communications device, and Telco account details.

Referring again to FIG. 3, the ICOM Registration Process 300 is initiated when a customer 302 contacts an ICOM server 301. The customer 302 proceeds to register 320 with ICOM 301 by providing ICOM 301 with authenticating information. ICOM 301 then communicates with Telco 305 to ascertain the account details 321 of the mobile communications device that the customer 302 is attempting to register. ICOM 301 then receives details 322 pertaining to the customer Telco account and further, the customer CLI information specific to the customer's mobile communications device, which is relevant to the Payer_ID field presented in Table 1.

After ICOM has obtained the required authenticating information from Telco 305 about customer 302, the ICOM Registration Process subsystem 300 continues when ICOM payment server 301 contacts a financial institution such as a Bank 303 for the purposes of establishing 323 an ICOM customer account. Bank 303 typically responds to ICOM 301 by sending ICOM an encrypted PIN and bank account details 324 for the registering customer 302. After Bank 303 and ICOM 301 have completed the account set-up procedure 323 and account detail 324 steps of the ICOM Registration Process 300, Bank 303 sends the customer 302 a secure PIN mailer 325, which customer 302 must use to access the customer's ICOM customer account. Bank 303 can provide customer 302 with mailer 325 using a variety of means, including by electronic mail, facsimile, or by regular post.

After the customer has successfully completed the ICOM Registration Process shown in FIG. 3, the customer can elect to establish the security or authorization procedures for accessing the ICOM customer account using the ICOM Security Setting Process subsystem presented in FIG. 4. Such procedures can be established based on, without limitation, the amount of the payment, the identity of one or more authorized users, and/or an authorization challenge where a series of user-defined questions and answers are used to authenticate the user attempting to initiate the remote payment transaction using a particular ICOM account.

FIG. 4 shows an exemplary embodiment of the ICOM Security Setting Process subsystem. Using the ICOM Security Setting Process subsystem 400, a customer 402 can engage the ICOM payment server 401 to establish and control the particular security parameters for a remote payment transaction using one or more of the registered ICOM customer accounts, where the accounts were previously established using the ICOM Registration Process shown in FIG. 3.

According to the present invention, an ICOM customer 402 uses a mobile communications device to establish the operative security settings for a specific payment transaction originating from a specific ICOM customer account.

In one embodiment of the present invention, the customer 402 initiates a session with the ICOM server 401 by accessing the customer ICOM account using identifying information 420 established during the ICOM Registration Process of FIG. 3, including CLI information and the assigned PIN. ICOM then presents the customer 402 with one or more security procedures 421, which can be optionally applied to the customer's ICOM account.

Following the security procedure selection step 421, ICOM accordingly proceeds to engage the customer 402 in a series of questions and answers so that customer 402 can optimize the account security for a payment transaction having a particular payment value or range of payment values.

For example, using the Security Setting Process subsystem 400, the customer 402 can input to ICOM 401 an authorization challenge comprising one or more user-defined questions and answers which define the level of security for one or more customer-specified transaction amounts 422. For example, a customer can assign one question and answer for a transaction amount between $0.01 and $100, and another question and answer for a transaction amount having a value between $100 and $1000 and so forth.

Alternatively, a customer can elect not to have a question and answer associated with any transaction value, or for a transaction having a low payment value.

According to the question and answer step 422 of the ICOM Security Setting Process subsystem 400, if customer 402 elects to assign a question and answer challenge to a transaction, ICOM will then prompt the customer 402 to define the associated maximum amount of the transaction, or alternatively, a range of values for the transaction amount. After completion of this step 422, the ICOM payment server 401 will subsequently confirm 423 with customer 402 the authorization settings that were established using the ICOM Security Setting Process subsystem 400.

In another embodiment of the ICOM Security Setting Process subsystem 400, the confirmation step 423 follows a customer indication that the preferred security settings have been completed. The confirmation step 423 commences when ICOM 401 reviews each question and answer challenge for a transaction value range or transaction value maximum. Each review is confirmed by a customer response. Such customer response includes, but is not limited to, a customer confirmation that the challenge is acceptable, a customer request for amendments to the established security settings, or a customer request to clear all established security settings and begin anew.

In a further aspect of the confirmation step 423 of the ICOM Security Setting Process 400, customer 402 can select a security procedure where the confirming step 423 includes confirming that the payment instruction has been executed using a mobile communications device that registered with that specific ICOM account. Such security can be achieved by comparing the officially registered phone number with the Calling Line Identification (“CLI”) originating from the mobile device being used to conduct the transaction with ICOM. This optional confirmation may be desirable if the customer 402 requires only minimal level of security such as for a low value payment transaction.

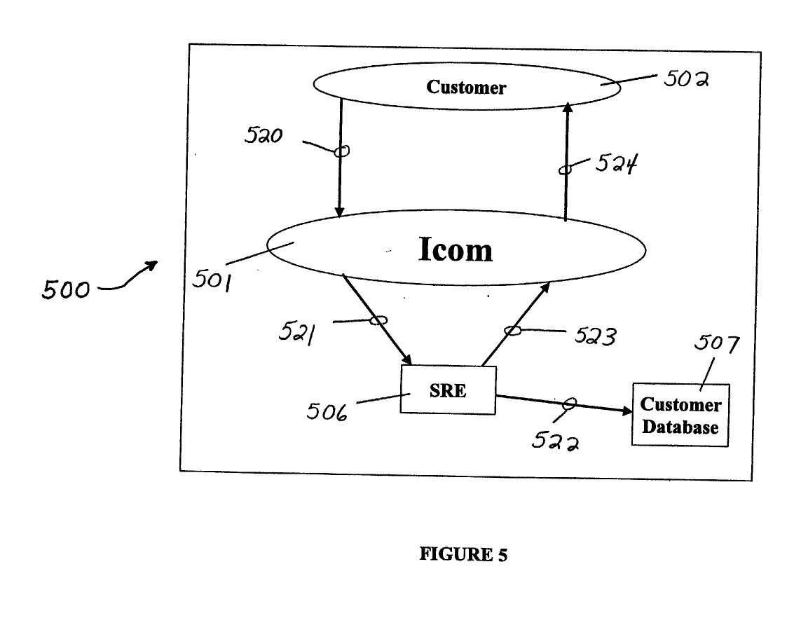

FIG. 5 illustrates one embodiment of the ICOM Security Authorization Process subsystem 500. Using the ICOM Security Authorization Process subsystem 500, a customer 502 can engage the ICOM payment server 501 to implement additional security measures, complementing those measures presented in FIG. 4, to establish an authorized user or an authorized group of users for one or more ICOM customer accounts.

This exemplary embodiment features a security rules engine 506 (“ICOM SRE”), which is part of the ICOM payment server 501. The ICOM SRE 506 monitors activity associated with an ICOM customer account to decide whether to accept a customer payment instruction as authentic, or alternatively, to request additional account information from the user according to the security protocols implemented with the Security Setting Process shown in FIG. 4.

Referring again to FIG. 4, another embodiment of the ICOM Registration Process features a CVLS subsystem, which provides the customer 402 a means of implementing preferred security parameters for a remote payment transaction or series of transactions.

Because the ICOM CVLS subsystem permits a customer to establish one or more additional ICOM customer account users, the ICOM SRE of FIG. 5 may thus require authorization from the registered ICOM account holder for each additional account user. Such authorization can last for a single payment transaction, or alternatively for an unlimited number of payment transactions for the authorized user. For example, a parent can authorize a child as an additional user and permit the child to spend up to a predetermined amount without further authorization. If the child requires an amount over this pre-established spending limit, the ICOM SRE would seek authorization from the parent before proceeding with the requested transaction. Alternatively, the parent can authorize the child to have unlimited access to the account, i.e., without any restrictions in the transaction amount.

Referring again to FIG. 5, in an exemplary embodiment of the ICOM Security Authorization Process subsystem 500, the ICOM payment server 501 initially identifies a customer 502 using the CLI and PIN information originating from the customer's communications device as illustrated in FIG. 4.

After ICOM 501 has successfully identified the remote caller as an authorized user of the ICOM customer account, ICOM 501 then proceeds with the payment transaction request from the customer 502, by generating a unique payment instruction code to identify the transaction. The customer 502 transmits data to ICOM 501, using the FBPG format payment frames, such data containing the identity of the payee, the type of goods or services being bought, and the amount of the transaction. Based on this information, ICOM 501 can apply a security measure to the transaction, where the customer 502 has established such measure using the ICOM SRE 506. This combination of features operates to prevent repudiation of the remote payment transaction by the customer 502 once the customer 502 has initiated a payment instruction to the ICOM server 501.

For example, the customer 502 can request 520 ICOM 501 to conduct a payment transaction having a specified value for the purchase of goods from a merchant. ICOM server 501 then ascertains 521, by contacting ICOM SRE 506, if the customer 502 has established any security measures for using the ICOM customer account to pay for a transaction having the specified value. The ICOM SRE 506 consults 522 a customer database 507 to check for any such security measure 523. If a security measure exists for this account and value amount, then ICOM SRE 506 executes such measure 523 by providing the security authorization parameters to ICOM payment server 501. If no such measures exist, ICOM proceeds with the payment; if such measures have been established, then ICOM 501 initiates the security challenge 524 with the customer. The customer 502 must successfully answer the challenge before ICOM releases the specified payment value to the merchant.

Typically, a customer 502 will successfully clear an existing security measure by accurately completing the challenge comprising one or more questions and answers 524. Once the authorized security procedures have been activated and transaction completed, the customer 502 is no longer able to cancel, dispute, or otherwise invalidate the payment transaction to the merchant.

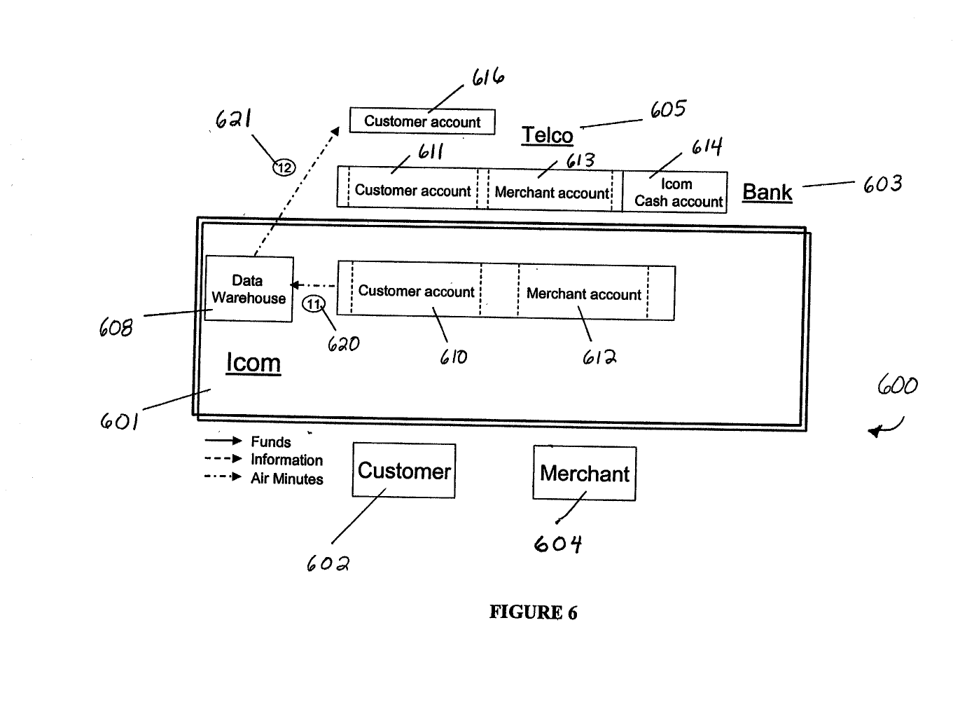

FIG. 6 shows one embodiment of the ICOM Air Time Loyalty Bonus subsystem 600. To cultivate and maintain customer loyalty, this loyalty subsystem provides a reward to a customer 602 based on one or more usage factors, such as the balance of funds in the ICOM customer account, the volume of transaction activity, and/or the value of such transactions. Furthermore, the server includes a data warehouse having a processor that calculates the loyalty bonus according to the usage factors for a particular time period such as a day, week, or month.

The payment server 601 includes a loyalty data storage warehouse 608 that calculates and stores the balance of the earned award. A customer 602 can view the loyalty award balance anytime during a payment session. One example of a loyalty bonus includes, but is not limited to, additional free airtime minutes that are electronically deposited 621 in the customer's Telco account 616, which sponsors the customer's mobile communications device. Alternatively, the loyalty bonus can be electronically deposited to a third party Telco account that is specified by the ICOM customer 602.

The customer 602 can optionally elect to authorize one or more merchants 604 to gain access to ICOM customer confidential information during a payment transaction. This information can, without limitation, include loyalty award data that is stored in the loyalty data warehouse 608 on the ICOM server 601. The merchant 604 may utilize the customer loyalty data to determine if the customer 602 falls into a merchant's preferred customer profile. If customer does fall into the merchant's profile, the merchant 604 can then instruct ICOM to notify the customer 602 of any special offers for the merchant's goods or services.

An ICOM customer 602 can optionally register for an enhanced loyalty bonus program, if such ICOM customer 602 anticipates reaching the required higher level of ICOM activity or average balance to trigger a larger loyalty reward. The enhanced loyalty bonus program provides an enhanced bonus that is larger than the bonus offered by the basic loyalty bonus program, thus serving as an incentive for greater customer patronage of the ICOM system 601.

Referring again to FIG. 6, a customer engages the ICOM payment server 601 and uses the ICOM Loyalty Bonus Process subsystem 600 to obtain the customer's current loyalty award balance. The customer 602 can also instruct the ICOM server 601 to transfer 621 the award balance, as free airtime minutes, from a loyalty data warehouse 608 to a customer Telco account 616.

In another embodiment, the customer 602 has conducted a required number of remote payment transactions and/or has maintained a particular ICOM customer account value to obtain a loyalty bonus. Such ICOM customer account value and/or activity is electronically stored on a data memory within the ICOM server 601, and can be transferred 620 to a loyalty data warehouse 608 at a specific time interval, or alternatively upon customer 602 demand. Loyalty data warehouse 608 is preferably a separate subsystem electronically coupled with the ICOM payment server 601, and is specialized for calculating and storing the reward information for an ICOM customer account 610.

Following the data transfer step 620, the loyalty data warehouse 608 calculates the loyalty bonus award for the customer 602. Such loyalty bonus award can include, without limitation, free airtime minutes from the Telco 605 that operates the customer's mobile phone. After loyalty data warehouse 608 calculates the customer bonus and converts this bonus into airtime minutes, the data warehouse 608 awaits a customer instruction before transferring all or part of the airtime minutes loyalty bonus to the customer's Telco account 616. The warehouse 608 accomplishes this transfer by instructing Telco 605 to electronically deposit 621 these airtime minutes into the customer's Telco account 616.

In a further embodiment of the ICOM Loyalty Bonus Process (not shown in FIG. 6), ICOM 601 permits customer 602 to transfer any portion of the loyalty bonus to a beneficiary party also holding an active Telco account. A customer can initiate such a loyalty bonus transfer by providing the ICOM server account number of the beneficiary. The beneficiary may already be included in an established customer address list. Following the customer's transfer request, ICOM first confirms that the requested award is available in the customer's ICOM account prior to instructing Telco to credit the award to the beneficiary's Telco account. In a further embodiment, ICOM preferably confirms the award transfer with the customer and/or beneficiary. The confirmation step can take place using, for example, a voice confirmation or, alternatively, by a Short Message Service (SMS) to the mobile communications device.

The ICOM Loyalty Bonus Process 600 also provides an option for customer 602 to create one of more beneficiary groups for the purpose of distributing the accumulated loyalty bonus. For example, a customer can designate a family group having a head, or joint heads of the family, or other groups subject to restricted spending limits and restricted types of merchants.

According to the present invention, ICOM operates according to a general payment scheme where a user can transact a remote payment from any location where the mobile communications device can contact the ICOM server. Furthermore, the customer can carry out the remote payment transaction using a range of different accounts. Therefore, ICOM is well suited for the remote purchase of goods and services delivered over a global communications network such as the Internet.

To accomplish a secure and remote payment for these goods and services using a remote communications device, such as a mobile phone, ICOM provides several safeguards, including the ability to generate a contextually unique payment instruction code (PIC), a double blind security mechanism that protects the identity and privacy of the payer and the payee, and an automatic delivery confirmation method which notifies the relevant parties of the transaction status.

According to the present invention, ICOM generates a PIC as part of the system for remote payment of an Internet purchase. Such PIC includes several features designed to minimize any potential security hazards commonly associated with these kinds of transactions. In one embodiment of the PIC, the code includes, for example, a dedicated merchant phone number answered by ICOM, the customer's PIN number, an amount of the remote payment, and a payment reference number.

The dedicated merchant phone number is preferably a direct dial number assigned by ICOM. The merchant phone number is responded to by one or more ICOM subsystems that are preferably dedicated to that particular merchant phone number. An ICOM customer who frequently uses a particular merchant can optionally add this direct dial number as a speed dial or phone book entry into their mobile phone. Also, the customer PIN is a code having one or more of a combination of numbers or letters, such code is known only to the customer and the ICOM security system. Finally, ICOM generates a short and unique payment reference code that is used to link the ICOM payment to those goods or services that the ICOM customer has ordered from the merchant.

A customer can purchase goods or services from a merchant on the Internet by initiating a remote payment session with ICOM. To accomplish the payment transaction, the customer and merchant follow a multi-step procedure.

For example, a customer surfing the World Wide Web (“web”) can come to a merchant's web page that requires a payment to the merchant in order for all of the information associated with the web page to be viewed. The customer can send a request to the merchant to buy the information. The merchant receives this request and, in turn, the merchant sends a request to ICOM to generate a unique reference number for the transaction.

ICOM then generates a short identifying reference number specific to the transaction, and provides the number to the merchant. ICOM ensures that the reference number is as short as possible while remaining unique for all outstanding payment requests for this amount and for this merchant. Such a short code is optimal for a customer during the process of entering in the payment instructions to ICOM.

The merchant then displays the transaction information, including the short identifying reference number and the price of the information, to the customer on a web page on the Internet. This web page is preferably viewable at the website that displays the merchant's available goods and services to the customer. The customer can view the web page using a display that can be situated on the communications device, or alternatively, the display can be part of a desktop computer environment.

The customer then dials the dedicated merchant number at ICOM using the customer's mobile communications device. After the customer establishes a connection with ICOM, the customer enters in the short identifying reference number and the price, as well as any information needed to satisfy the customer's own security rules, thereby permitting ICOM to debit the customer's ICOM account.

ICOM then matches the reference number to the merchant, transfers the funds to the merchant's ICOM account, and informs the merchant that the transaction associated with the short reference number has been paid for.

The merchant then links the transaction reference number with the customer's purchase request and releases the purchased information to the customer. Once the information is loaded in the customer's web browser, an electronic message can be sent back to the merchant's web server confirming delivery.

Another embodiment of the ICOM Internet Payment scheme that provides secure Internet payments features a double blind security system. Such double blind security protects the identity and privacy of both the paying party and the payee party during the course of the remote payment transaction.

As described above, the customer's remote payment instruction is received by ICOM, namely by answering the dedicated phone number assigned to the merchant. After this instruction has been received, ICOM has sufficient information to execute the payment request, first by confirming the customer PIN number sent from the customer mobile communications device (identified by the CLI), prior to processing the amount of the payment and the merchant ID.

Because the short reference number is not sufficient to identify the items that the customer requested for purchase, ICOM is adapted to preserve the customer's privacy by providing to the merchant both the amount of the remote payment and the short reference number. However, should the customer request a refund from the merchant using the ICOM payment system as an intermediary, the customer may optionally provide identifying information to the merchant for the purpose of receiving the refund.

In one embodiment, the customer identity is not required by the merchant nor is it provided to him, thereby preserving the customer's anonymity. Once the merchant has received confirmation of the remote payment, the merchant can identify the item to be delivered from a temporary merchant database in cooperation with a web session key that identifies where the item is to be delivered to the customer. Using this ICOM server, the merchant does not gain access to the identity of the customer, thus allowing complete privacy of the customer's personal information.

In a typical cash transaction, a merchant does not learn the identity of the paying party, as cash is totally anonymous. However, in a typical credit card transaction, the merchant usually takes precautions to protect themselves from fraud by implementing various procedures that function to uniquely identify a customer.

Using the ICOM customer account of the present invention, a customer can preserve anonymity by paying a merchant in the same way as he would with cash, thus affording complete privacy of the customer identity. For example, the customer can instruct the ICOM payment server to transfer a payment value from their ICOM customer account to the merchant ICOM account using the above-described ICOM subsystems, each subsystem affording complete anonymity. Therefore, the merchant does not learn the identity of a customer.

The ICOM Internet Payment scheme providing secure Internet payments preferably includes an automatic delivery confirmation (or “ADC”) subsystem. This system notifies a merchant when the content displayed on the merchant's chargeable web pages, or other intangible goods or services, are delivered to a new customer or an existing customer. Each of the chargeable web pages contains a signal, such as a small JAVA applet, that is adapted to send a confirmation message back to the merchant's Web server after the content displayed on the chargeable page is loaded or attempted to load on the customer's browser. This feature provides the merchant with the ability to monitor any potential or actual transactions occurring using the merchant's website.

The ADC component provides the merchant with such benefits including, but not limited to, a means to authorize the repeated delivery of a chargeable web page if there was a system failure during initial delivery of such page to the customer; an audit log in case of disputed transactions where the merchant system can instruct ICOM to refund charges to the ICOM customer account for those items not delivered or for some other commercially acceptable reason; and a mechanism to keep the payment reference number as short as possible. For example, immediately upon confirmation of a delivery from merchant to customer, the associated payment reference number can be recycled for any future ICOM transaction. Therefore, for subsequent transactions with new or existing customers, ICOM will not need to generate different or longer sequential reference numbers for the purpose of tracking subsequent purchases.

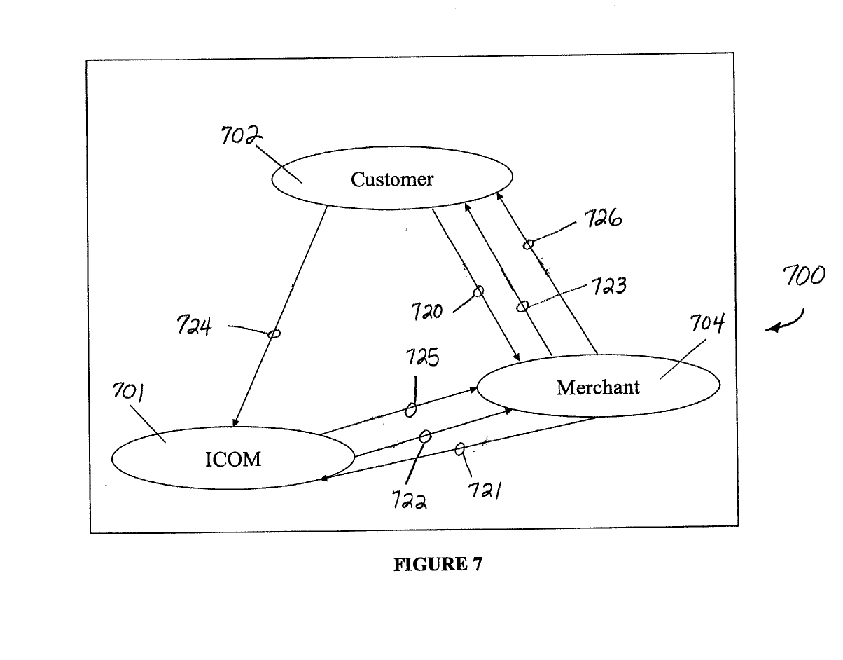

FIG. 7 shows one embodiment of the ICOM Internet Payment Process subsystem 700. ICOM customer 702 uses a mobile communications device to pay a remote ICOM enabled merchant 704 for goods or services on the Internet.

Accordingly, customer 702 views merchant 704 web page displaying a product or service of interest to the customer using a display such as a display screen on the communications device, or a display situated in a desktop environment. The merchant web page requires a payment when the product or service is requested. The customer 702 selects an option 720 provided on the web page to continue the ordering process, such option is typically represented as a standard button or as an alphanumeric response.

Merchant 704 receives the customer order request, and subsequently requests ICOM 701 to generate a unique reference code 721 for this particular customer transaction. ICOM 701 generates the unique reference code and provides 722 merchant 704 with the unique reference code generated for the customer transaction. Alternatively, the steps directed to requesting and generating the unique reference code, step 721 and step 722, can be accomplished using ICOM software that is installed on the merchant's server.

Once a unique customer reference number has been generated, merchant 704 then publishes the unique reference code to the customer 702 on the merchant web page and further provides the customer 702 with the total purchase amount of the transaction 723. The customer then communicates with ICOM 701 using a mobile communications device to provide ICOM 701 with the CLI and PIN information 724. Customer also provides the unique reference code and payment amount 724. The transaction is completed according to the customer established security authorization procedures, for example, according to FIGS. 4 and 5, so that the proper amount of funds can be debited from the ICOM customer.

ICOM then matches the reference number to the merchant and transfers the funds to the merchant's ICOM account. Following the transfer of funds, ICOM 701 advises 725 merchant 704 that the unique reference ID has been paid for. Merchant then releases 726 the merchant web page to customer 702 for viewing. If the web page was successfully loaded on the customer's browser, such browser sends a message to merchant 704 confirming that the page was successfully received by customer 702.

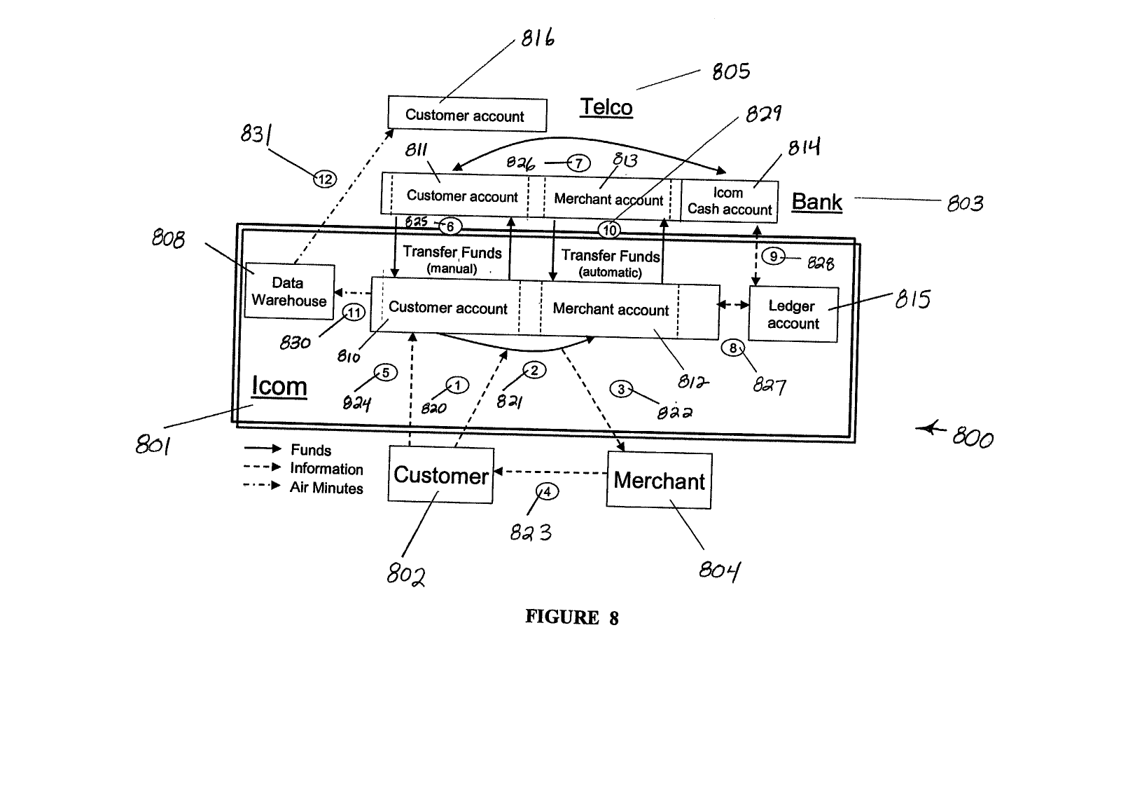

FIG. 8 shows an exemplary overview of the operation and function of the ICOM Remote Payment method and system 800 using the ICOM payment server 801. As described in the various embodiments, the payment server 801 includes one or more ICOM customer accounts 810, one or more merchant accounts 812, a ledger account 815 and a loyalty data warehouse 808. Together, these ICOM components function using a series of coordinated protocols that initiate and execute a remote payment, funds transfer, and account management.

In one embodiment, ICOM payment server 801 receives a customer instruction 820 to pay a merchant 804 by transferring funds 821 from the ICOM customer account 810 to an ICOM merchant account 812. ICOM 801 carries out the transfer 821 and then advises 822 the merchant 804 of the customer payment. The merchant 804 optionally confirms 823 the payment with the customer 802 using means external to the ICOM payment server 801.

After customer initiates a session with ICOM using the registered mobile phone, customer 802 can instruct the ICOM payment server 801 to perform one or more tasks, such as requesting 824 an ICOM account balance, or manual (i.e., customer initiated) transfer of funds 825 from and between an external bank account 811 and an ICOM customer account 810. The ICOM payment server 801 can transfer funds 829 between the merchant ICOM account 812 and the merchant Bank account 813 in an automated fashion.

The ICOM payment server also features an ICOM ledger account 815 that receives 827 ICOM customer and merchant data on a regular basis, such as daily, weekly or monthly. The ICOM ledger account 815 is in communication with the ICOM cash bank account 814, where ICOM 801 transmits 828 ledger account information so Bank 803 can accordingly balance and otherwise manage the ICOM cash bank account 814.

The ICOM server 801 also includes a data warehouse 808 that receives, calculates, and stores 830 the customer loyalty bonus. Following this calculation and upon customer request, ICOM can deposit 831 this bonus to a customer's Telco account 816 or another Telco account designated by the customer 802.

Referring again to FIG. 8, the major ICOM processes are shown, as well as the operative entities such as the ICOM server 801, the Bank 803, Customer 802, Merchant 804, and the Telco 805. As shown in FIG. 8, these operative entities are depicted as separate entities. In practicing the present invention, however, ICOM could be an entity that exists as a direct part of, for example, the Bank 803 or the Telco 805. Moreover, while FIGS. 2, 6, and 8 show the customer, merchant, and ICOM accounts at one financial institution (“Bank”) for convenience of illustration, it should be clear to one of ordinary skill in the art that customer, merchant, and service provider financial accounts can be maintained at different financial institutions (e.g., customer financial account can be held at a credit union, merchant financial account can be held at a first bank, and ICOM financial account can be held at a second bank).

In one embodiment, the operative processes of the ICOM Remote Payment method and system 800 are implemented using an object-oriented computer programming language having support for integration with legacy enterprise systems, including but not limited to Java and Enterprise Java Beans.

In another embodiment, the operative entities would require little or no modification to be ICOM-enabled for the purposes of executing a remote payment. For example, a fund transfer from Bank 803 to an ICOM customer account 810 or merchant ICOM account 812 can be achieved using a standard automated teller machine (“ATM”).

The ICOM system of the present invention features a unique configuration of known standard and modified software packages and system modules for the function and operation of the ICOM Remote Payment process. Such software packages and system modules can be implemented using the above-described embodiments, and can include, for example, one or more financial systems to handle payment and cash accounts; a core system including a session management module, a security service, a loyalty program manager, customer data manager, and a data storage warehouse component. Additionally, ICOM can feature a voice server module, a Telco interface, and help desk interface for access by a customer or other authorized party. This combination of one or more interrelated packages optimizes security, independence and flexibility of and between the subsystems of the ICOM payment server.

Through the process and system of the present invention, a customer can securely provide a remote payment to a merchant while maintaining complete confidentiality of the customer identity. Furthermore, the ICOM system minimizes the risk of fraud for a personal or commercial transaction by permitting the customer to set the level of security authorization for each account, so a transaction cannot be subsequently repudiated.

ICOM also manages transactions having a payment values ranging from micro amounts to large sums, according to instructions provided by a customer once the customer successfully links the mobile phone to an account on the ICOM payment server. The phone is used, without the need for additional devices, to manage the account by sending and receiving payment instructions, as well as acting as a physical token used as part of the account security.

In addition to providing a variety of security mechanisms in combination with the remote payments using ICOM, the customer is rewarded for account usage via a loyalty program manager. Such loyalty manager can provide the customer with a bonus for consistent usage or high value of the ICOM account. For example, the bonus may be free airtime minutes from the contracting company for the remote communications device. The customer can individually utilize these airtime minutes themselves or alternatively, transfer these minutes to other Telco customers.

The embodiments of the present invention relate to computer products and communications devices having a computer readable medium with program code thereon for performing various computer-implemented operations. The media and program code may be those specially designed and constructed for the purposes of the present invention, or they may be of a kind well known and available to those having ordinary skill in the computer software or communications arts.

Although the foregoing invention has been described in some detail for purposes of clarity of understanding, it will be apparent that certain changes and modifications may be practiced within the scope of the appended claims. For example, many of the processes described herein may be performed, in total or in part, by external or internal support systems implemented by the ICOM Remote Payment method and system. Also, any network capable of performing routing functionality between a client device and a payment and merchant server may be used. Furthermore, ICOM can include a physically separate payment server, or its functionality may be incorporated directly into a software package ideally suited to be installed on a remote computer or communications device.

While the invention has been described in conjunction with certain embodiments, these described embodiments should be taken as illustrative and not restrictive, and the invention should not be limited to the details given herein but should be defined by the following claims and their full scope of equivalents.

What is claimed is:

1. A computer-based remote payment transaction system comprising:
a server operated by a service provider, said server including a data memory for storing two or more server accounts, said server accounts including a first party server account and a second party server account, said server configured to:
(a) establish the first party server account using an account registration subsystem;
(b) authenticate an authorized user of the first party server account using an authentication subsystem;
(c) receive an electronic payment instruction via a mobile communications device from the authorized user, said payment instruction requesting that a purchase value be transferred from the first party server account to the second party server account;
(d) notify the authorized user via the mobile communications device that the payment instruction was received;
(e) transfer the requested payment value from the first party server account to the second party server account;
(f) receive an electronic transfer instruction via the mobile communications device from the authorized user, said transfer instruction ordering that a requested value be transferred from an account associated with the first party at a first financial institution to the first party server account;
(g) add the requested value to the first party server account;
(h) instruct the financial institution to transfer funds corresponding to the requested value from the first party financial institution account to an account associated with the service provider at a second financial institution;
(i) update the data memory; and
(j) provide a reward for using the server via a customer loyalty subsystem.

2. The remote payment system of claim 1, wherein the mobile communications device is configured to:
(a) generate a signal for transmitting the electronic payment instruction to the server;
(b) generate a signal for transmitting the electronic transfer instruction to the server;
(c) transmit caller identification information to the server;
(d) display first party server account information; and
(e) receive a signal representing a confirmation receipt for the payment transaction from the server.

3. The remote payment system of claim 2, wherein the first financial institution and the second financial institution are the same financial institution.

4. The remote payment system of claim 1, wherein the server is configured to notify the authorized user that the server received the electronic payment instruction using a secure communications link to the mobile communications device.

5. The remote payment system of claim 1, wherein the mobile communications device comprises a mobile phone or a personal digital assistant.

6. The remote payment system of claim 1, wherein the server authentication subsystem is configured to:
(a) store an authentication credential established by the authorized user, where the authorized user accesses the server to request the payment instruction secured by the authentication credential, wherein the authentication credential is:
(i) in existence at the server prior to the payment request, and
(ii) a unique identifier of the authorized user;
(b) solicit a response associated with the payment transaction via a challenge, where the challenge is transmitted by the server to the authorized user;
(c) accept an answer to the challenge from the authorized user; and
(d) transmit the authorization credential from the server to the mobile communications device following a determination by the server that the answer satisfies the challenge,
wherein the authentication subsystem is operable in a repeatable, on-demand manner by the authorized user using the communications device.

7. The remote payment system of claim 6, wherein the server authentication subsystem is further configured to use the authentication credential to allow the authorized user to proceed with the payment transaction.

8. The remote payment system of claim 6, wherein the server authentication subsystem is further configured to implement a security rules engine for authenticating the payment instruction, wherein if the payment instruction is determined to be non-authentic, the engine requests further information from the authorized user to authenticate the instruction.

9. The remote payment system of claim 6, wherein the server is configured to receive input via biometric techniques, said biometric techniques including voice recognition or signature recognition.

10. The remote payment system of claim 1, wherein the server is configured to update a server ledger account to reflect a change in the total funds available in all server accounts affected by the payment transaction.

11. The remote payment system of claim 1, wherein the server customer loyalty subsystem includes a data warehouse that is configured to:
(a) receive account usage information from the data memory, the usage information including average account balance or transaction frequency that is associated with a first party account on the server;
(b) compile and analyze the usage information to calculate a loyalty award;
(c) convert the loyalty award into airtime minutes;
(d) transmit the airtime minutes to a telecommunications account; and
(e) transmit usage information to the authorized user via the mobile communications device.

12. The remote payment system of claim 11, wherein the server receives from the first party a request to transfer the loyalty award to a third party server account from the first party server account, wherein said third party is an authorized user of a third party server account.

13. The remote payment system of claim 11, wherein the telecommunications account is associated with the first party.

14. The remote payment system of claim 11, wherein the telecommunications account is associated with one or more beneficiary parties.

15. The remote payment system of claim 11, wherein the server customer loyalty subsystem is further configured to:
(f) store the loyalty award information within the loyalty data warehouse on the server; and
(g) periodically receive the usage information from the data memory.

16. The remote payment system of claim 1, wherein the payment transaction cannot be repudiated by the first party.

17. The remote payment system of claim 1, wherein the payment transaction cannot be repudiated by the second party.

18. The remote payment system of claim 1, wherein the first party is a customer.

19. The remote payment system of claim 1, wherein the second party is a merchant.

20. A computer-based remote payment transaction system via the Internet comprising:
a server operated by a service provider, said server including a data memory for storing one or more server accounts, said server accounts including a first party server account and a second party server account, said server configured to:
(a) establish the first party server account and the second party server account using an account registration subsystem;
(b) generate a unique reference code for a payment transaction upon a request of a second party, after the second party receives a purchase request from the first party via the Internet;
(c) provide the unique reference code to the second party;
(d) answer an incoming call from the first party to a second party phone number dedicated to the second party;
(e) receive a first party personal identification number linked to the first party server account for authenticating the first party as an authorized user of the first party server account;
(f) receive a transaction amount and the unique reference code from the first party for the payment transaction, wherein the server is configured to automatically match the unique reference code received from the first party to the unique reference code generated upon the request of the second party; and
(g) transfer the payment from the first party server account to the second party server account.

21. A computer-based remote payment transaction method using a server operated by a service provider, said server including a data memory for storing two or more server accounts, said server accounts including a first party server account and a second party server account, comprising the steps of:
(a) establishing the first party server account using an account registration subsystem;
(b) authenticating an authorized user of the first party server account using an authentication subsystem;
(c) receiving an electronic payment instruction via a mobile communications device from the authorized user, said payment instruction including a payment value to be transferred from the first party server account to the second party server account;
(d) notifying the authorized user via the mobile communications device that the payment instruction was received;
(e) transferring the requested payment value from the first party server account to the second party server account;
(f) receiving an electronic transfer instruction via the mobile communications device from the authorized user, said transfer instruction ordering that a requested value be transferred from an account associated with the first party at a first financial institution to the first party server account;
(g) adding the requested value to the first party server account;
(h) instructing the financial institution to transfer funds corresponding to the requested value from the first party financial institution account to an account associated with the service provider a second financial institution;
(i) updating the data memory; and
(j) providing a reward for using the server via a customer loyalty subsystem.

22. The remote payment method of claim 21, wherein the mobile communications device is configured to:
(a) generate a signal for transmitting the electronic payment instruction to the server;
(b) generate a signal for transmitting the electronic transfer instruction to the server;
(c) transmit caller identification information to the server;
(d) display first party server account information; and
(e) receive a signal representing a confirmation receipt for the payment transaction from the server.

23. The remote payment method of claim 22, wherein the first financial institution and the second financial institution are the same financial institution.

24. The remote payment method of claim 21, wherein the notifying step further comprises using a secure communications link to the mobile communications device.

25. The remote payment method of claim 21, wherein the mobile communications device comprises a mobile phone or a personal digital assistant.

26. The remote payment method of claim 21, wherein the authenticating step further comprises:
(a) storing an authentication credential established by the authorized user, where the authorized user accesses the server to request the payment instruction secured by the authentication credential, the authentication credential is:
(i) in existence at the server prior to the payment request, and
(ii) a unique identifier for the authorized user;
(b) soliciting a response associated with the payment transaction via a challenge, where the challenge is transmitted by the server to the authorized user;
(c) accepting an answer to the challenge from the authorized user; and
(d) transmitting the authorization credential from the server to the authorized user following a determination by the server that the answer satisfies the challenge,
wherein the authenticating step is operable in a repeatable, on-demand manner by the authorized user using the mobile communications device.

27. The remote payment method of claim 26, wherein the authenticating step further comprises using the authentication credential to allow the authorized user to proceed with the payment transaction.

28. The remote payment method of claim 26, wherein the authenticating step further comprises using a security rules engine for authenticating the payment instruction, wherein if the payment instruction is determined to be non-authentic, the engine requests further information from the authorized user to authenticate the instruction.

29. The remote payment method of claim 26, wherein the server receives input via biometric techniques, said biometric techniques including voice recognition or signature recognition.

30. The remote payment method of claim 26, further comprising updating a server ledger account to reflect a change in the total funds available in all server accounts affected by the payment transaction.

31. The remote payment method of claim 26, wherein the providing a reward step further comprises using a data warehouse for:
(a) receiving account usage information from the data memory, the usage information including average account balance or transaction frequency that is associated with a first party account stored on the server;
(b) compiling and analyzing the usage information to calculate a loyalty award;
(c) converting the loyalty award into minutes;
(d) transmitting the airtime minutes to a telecommunications account; and
(e) transmitting usage information to the authorized user.

32. The remote payment method of claim 31, wherein the server receives from the first party a request to transfer the loyalty award to a third party server account from the first party server account, wherein said third party is an authorized user of a third party server account.

33. The remote payment method of claim 31, wherein the telecommunications account is associated with the first party.

34. The remote payment method of claim 31, wherein the telecommunications account is associated with one or more beneficiary parties.

35. The remote payment method of claim 31, wherein the providing a reward step further comprises:
(f) storing the loyalty award information within the loyalty data warehouse on the server; and
(g) periodically receiving the usage information from the data memory.

36. The remote payment method of claim 21, wherein the payment transaction cannot be repudiated by the first party.

37. The remote payment method of claim 21, wherein the payment transaction cannot be repudiated by the second party.

38. The remote payment method of claim 21, wherein the first party is a customer.

39. The remote payment method of claim 21, wherein the second party is a merchant.

40. A computer-based remote payment transaction method via the Internet using a server operated by a service provider, said server including a data memory for storing one or more server accounts, said server accounts including a first party server account and a second party server account, comprising the steps of:
(a) establishing the first party server account and the second party server account using an account registration subsystem;
(b) generating a unique reference code for the payment transaction upon request of a second party, after the second party receives a purchase request from the first party via the Internet;
(c) providing the unique reference code to the second party;
(d) answering an incoming call from the first party to a second party phone number dedicated to the second party;
(e) receiving a first party personal identification number linked to the first party server account for authenticating the first party as an authorized user of the first party server account;
(f) receiving a transaction amount and the unique reference code from the first party for the payment transaction, wherein the server is configured to automatically match the unique reference code received from the first party to the unique reference code generated upon the request of the second party; and
(g) transferring the payment from the first party server account to the second party server account.
